(19) United States
(12) Patent Application Publication
(10) Pub. No.: US 2015/0371338 A1
(43) Pub. Date: Dec. 24, 2015

(54) PHARMACY CONTRIBUTION MANAGEMENT SYSTEM AND METHOD

(71) Applicant: SimpleSaveRx, Inc., Chandler, AZ (US)

(72) Inventor: George E. Herman, Chandler, AZ (US)

(21) Appl. No.: 14/748,765

(22) Filed: Jun. 24, 2015

Related U.S. Application Data
(60) Provisional application No. 62/016,190, filed on Jun. 24, 2014.

(51) Int. Cl. G06Q 40/08; G06Q 50/22; G06Q 30/06

(52) U.S. Cl. CPC G06Q 40/08; G06Q 30/0629; G06Q 50/22

(57) ABSTRACT

A pharmacy contribution management method comprises analyzing historical claim data, determining a tiered model for prescription contributions, the tiered model describing a plurality of prescription cost tiers and recommended prescription contribution for each of the plurality of prescription cost tier, permitting an organization to determine a prescription contribution for each of the plurality of prescription cost tier, enabling a member associated with the organization to shop of lowest price drugs via pass-through pricing from the pharmacies, receiving a prescription claim from a pharmacy arising from a prescription purchase by the member associated with the organization, and transmitting the prescription contribution for the organization to the pharmacy, so that the pharmacy may charge the member an amount equal to a price of the prescription minus the organization's prescription contribution.

### RELATED APPLICATION

This patent application claims the benefit of U.S. Provisional Patent Application Ser. No. 62/016,190 filed on Jun. 24, 2014, incorporated herein in its entirely by reference.

### FIELD

The present disclosure primarily relates to a pharmacy contribution management system and method.

### BACKGROUND

In the United States, drugs account for 10 percent of the country's $2.7 trillion annual health bill. The U.S. spends almost $1,000 per person per year on pharmaceuticals, which is around 40% more than the next highest spender, Canada, and more than twice as much as than countries like France and Germany spend, even though the average American takes fewer prescription medicines than people in France or Canada.

Many people in the U.S. obtain medical insurance through their employers. The typical insurance policy has predefined a copay amount that the employees pay for a given prescription. Because the amount that the employee is responsible for is fixed, the prescription is often filled by the employee at retailers selected without regard to the total cost of the medicine. The cost of the medicine minus the copay is then the responsibility of the employer. As a result, employees have no incentive to shop for pharmacies where the medication is offered at lower prices, and the employer assumes all the risk for the balance of the transaction. The employer also has limited control over the amount that it ultimately becomes responsible for the prescriptions filled out by its employees.

### BRIEF DESCRIPTION OF THE DRAWINGS

FIG. 1 is a simplified block diagram of a networked computing environment in which the pharmacy contribution management system operates;

FIG. 2 is a simplified message flow diagram of an embodiment of the pharmacy contribution management system according to the teachings of the present disclosure;

FIG. 3 is a block diagram of an embodiment of an exemplary architecture of the pharmacy contribution management system and method according to the teachings of the present disclosure;

FIG. 4 is a simplified block diagram that illustrates various exemplary functions that are provided to members, via mobile app as well as web app according to the teachings of the present disclosure;

FIG. 5 is a simplified block diagram that illustrates various exemplary functions that are provided to employers, via mobile app as well as web app according to the teachings of the present disclosure;

FIG. 6 is a simplified block diagram that illustrates various exemplary functions that are provided to pharmacy partners, via mobile app as well as web app according to the teachings of the present disclosure;

FIG. 7 is a simplified block diagram that illustrates various exemplary functions that are provided to prescribers (e.g., physicians) according to the teachings of the present disclosure;

FIG. 8 is a simplified flowchart of an exemplary embodiment of the pharmacy contribution management process according to the teachings of the present disclosure;

FIG. 9 is a simplified illustration of an exemplary employer tiered contribution model in the pharmacy contribution management process according to the teachings of the present disclosure;

FIG. 10 is a simplified block diagram of an exemplary embodiment of the basic function blocks of the pharmacy contribution management process according to the teachings of the present disclosure;

FIG. 11 is a simplified illustration of an exemplary embodiment of the claims processing Rx dispensing process in the pharmacy contribution management process according to the teachings of the present disclosure;

FIG. 12 is a simplified illustration of an exemplary embodiment of the claims adjudication process in the pharmacy contribution management process according to the teachings of the present disclosure;

FIG. 13 is a simplified illustration of an exemplary embodiment of prior authorizations in the claim approval process in the pharmacy contribution management process according to the teachings of the present disclosure;

FIG. 14 is a simplified illustration of an exemplary embodiment of the appeals process in claim processing in the pharmacy contribution management process according to the teachings of the present disclosure;

FIG. 15 is a simplified illustration of an exemplary embodiment of the claim reversal process in claim processing in the pharmacy contribution management process according to the teachings of the present disclosure;

FIG. 16 is a simplified illustration of an exemplary embodiment of the financial processing for Rx payee reimbursement process in the pharmacy contribution management process according to the teachings of the present disclosure;

FIG. 17 is a simplified illustration of an exemplary embodiment of the financial processing for payer collections process in the pharmacy contribution management process according to the teachings of the present disclosure; and

FIG. 18 is a simplified illustration of an exemplary embodiment of the manufacturer rebate to employer process in the pharmacy contribution management process according to the teachings of the present disclosure.

### DETAILED DESCRIPTION

The traditional employer sponsored health insurance specifies fixed copay amounts that the employee must pay for certain healthcare services and prescriptions, and the employer is responsible for paying the balance. In this traditional pharmacy benefits manager (PBM) model, there are at least three ways that employers are put at a disadvantage. Pharmacies are not able to disclose drug prices through PBMs to pass their best pricing onto the consumers, and they are not able to compete based on pricing. Pharmacy benefits managers markup the cost of drugs that a pharmacy is willing to accept. As a result, employers are unable to predict and budget the Rx cost of its employees due to the variability of drug prices at various pharmacies.

The innovative Pharmacy Contribution Management (PCM) model flips the traditional benefits model (pharmacy benefits manager or PBM) on its head, substituting employer contribution for employee copay. The pharmacy contribution management system and method provides pharmacies with the employer's defined contribution percentage or amount, and collects the balance from the employee at the point of sale. Therefore, the employee is responsible for the balance, while the employer's Rx cost is fixed. By leveraging the present PCM system and method, employers can estimate an Rx budget amount with little variance in fluctuation. Using statistical analysis and analytics, an employer can set its own formularies and contributions to meet its budgetary goals. Employers may use a tiered contribution model to decide how much they are willing to pay for its employees' Rx spending. A tiered contribution model is offered in lieu of a traditional complex formulary. Drugs are grouped by category of their pricing, and the employer set the amount or percentage it wants to contribute to each pricing tier. The system is configured to take into account of historical claims against pharmacy partner pricing to provide recommendations for the tiered pricing ranges, as well as recommend how much the employer might contribute to help both the employee and the employer maximize savings. A further benefit is that the employees are encouraged and motivated to shop for lower drug prices using the tools of the system and permitting the pharmacies to compete for their business via pass-through pricing. This results in true transparent pricing without spreads and hidden costs that previously went to the middlemen.

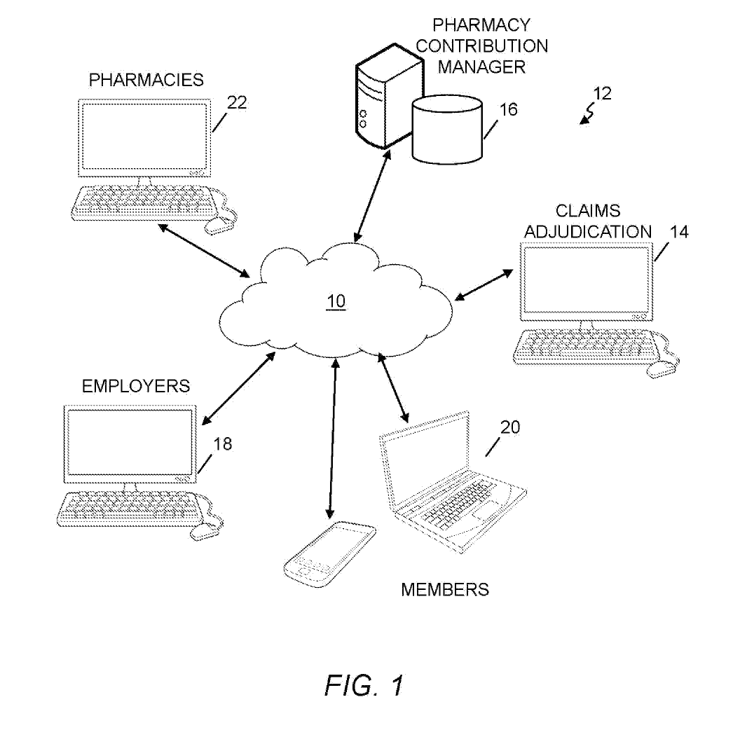

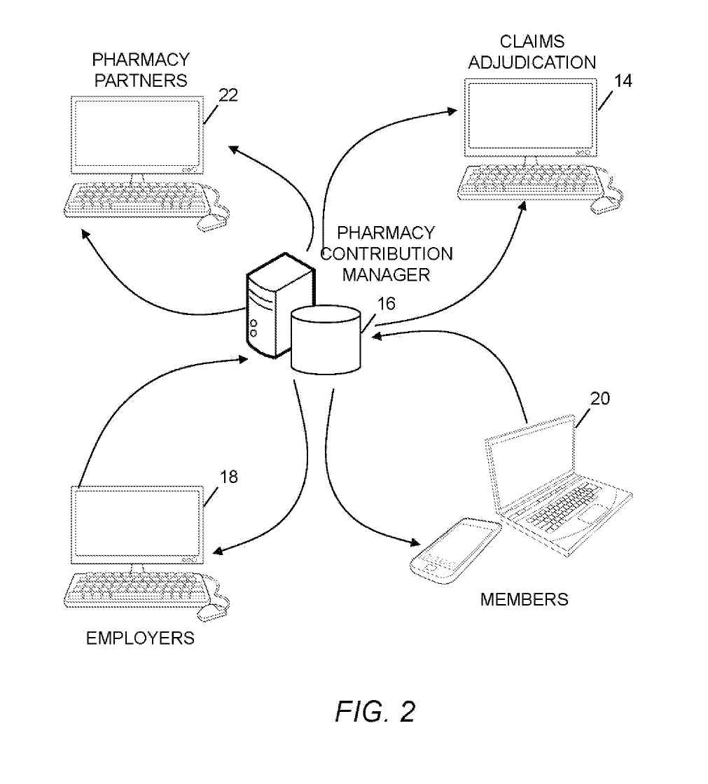

FIGS. 1 and 2 illustrate that pharmacy partners in the network, employers, members (employees) can communicate via a global computer network 10 with the pharmacy contribution manager system 12, via desktop web applications, mobile applications, and other suitable computing means. The system may further employ a claims adjudication system 14 with which it communicates via the computer network 10. All data are stored in databases 16 with redundancy backups, and are balanced to achieve efficient and speedy transactions and service. The employer companies 18, members/employees 20, and pharmacy partners 22 are able to communicate and access information via the computer network 10.

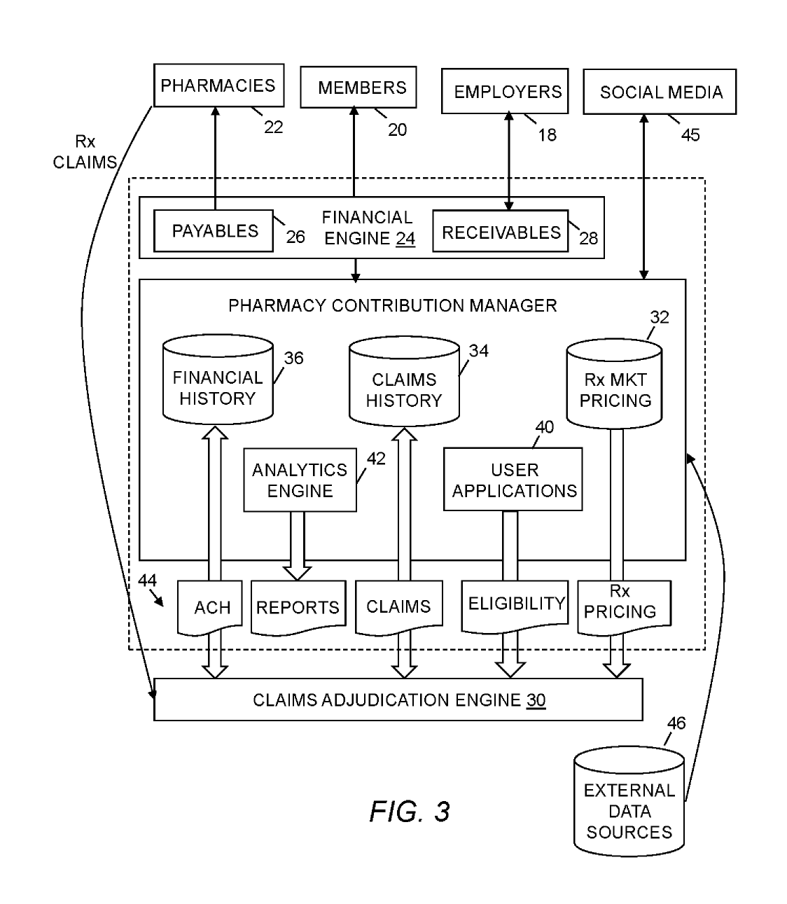

FIG. 3 is a block diagram that illustrates an exemplary architecture of the pharmacy contribution management system and method. The financial engine 24 performs many of the accounting and accounts payable functions (payables 26 and receivables 28). The claims adjudication engine 30 performs many of the functions associated with adjudicating Rx claims from the members. It is configured to access databases containing Rx market pricing data 32, claims history 34, and financial history 36. The pharmacy contribution management system includes user applications (web and mobile) 40 that provide access to the system by pharmacy partners, employee members, and employers. It also includes an analytics engine 42 that is configured to perform analysis on various data sets and provide reports 44, including ACH (Automated Clearing House), analytics, claims, eligibility, and Rx pricing reports. The system also interfaces with social media 45 and external data sources 46.

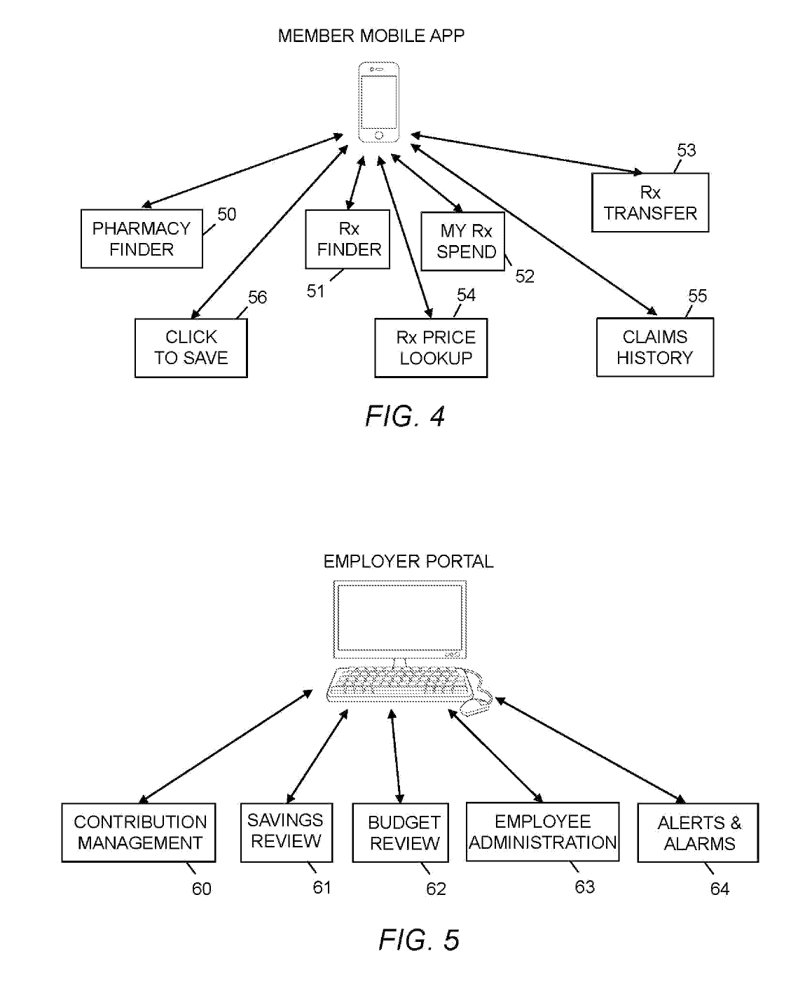

FIG. 4 is a simplified block diagram that illustrates various exemplary functions that are provided to members, via a mobile app as well as a web app, for example. A mobile application (and its web desktop equivalent) enables the employee/member to access many functions, including Pharmacy Finder 50, Rx Finder 51, My Rx Spend 52, Rx Transfer 53, Rx Price Lookup 54, Claims History 55, and Click to Save 56.

Pharmacy Finder—Employees or members may use the mobile app running on a smartphone or a suitable electronic device to find the lowest cost Rx (in real-time) with a nearby pharmacy in the pharmacy partner network or other available retailers. There are options to narrow the search to find, for example, pharmacies with drive-thru options, 24 hours locations, or offer value services such as immunization clinics. This concept promotes real-time location-based shopping, enabling members to search, in real-time, for the lowest prices in their area proactively and/or for a prescription while at the doctor's office. This function may utilize third party map apps such as GOOGLE MAPS to display a map showing the searched for pharmacy.

Rx Finder—the member may search for details on any prescription drug by name, or disease/indication. Members can look for available drug generics and alternatives, Rx pricing, and drug information including description, interactions, and more. Recognizing that certain patient demographics do not have high technology adoption rates, if a member does not use the technology proactively to search for prescription savings opportunities, the system will alert the member (via their preferred method such as email or text) that the prescription savings can be achieved for refills of the prescription and provide details on how to save. This approach guides patient behavior over time to drive proactive saving behaviors that benefit both members and employers.

My Rx Spend—the member may view the Rx history for his/herself and dependents and export Rx history for tax or historical use. A spend summary and projections for budgeting and review recommendations for saving is also available.

Rx Transfer—this feature presents the member with alternative pharmacies, generic vs. brand name, and alternative medications to maximize cost savings. The member may use this feature to easily transfer a prescription to a pharmacy partner their active refill. By increasing the ease of prescription transfers, patients are more likely to move their prescriptions to lower price pharmacies, which improves the likelihood of savings for both members and employers.

Rx Price Lookup—true pass-through real-time pricing from pharmacy partners is available to employee members that doesn't include spreads, hidden costs, or markups. The pharmacy partners promote their best prices and value without any middle men. Members can shop around for the Rx based on price, specials, service options, and location, all at the click of a button.

Click to Save—Based on a member's current drug spend, the Click to Save feature of the mobile application recommends pharmacies that will increase their savings on active prescriptions. The member may enter preferred distance and maximum number of pharmacies, and this feature will project the cost savings and list the lowest cost pharmacies in the selected area, as well as generic and therapeutic alternatives. This feature includes recommendations of moving to a different retail pharmacy, mail-order options, and fill alternatives.

A member may also set up his/her own Rx profile and for dependents. The member may set the mobile app to send reminders for upcoming refill straight to the mobile device or by email.

FIG. 5 is a simplified block diagram that illustrates various exemplary functions that are available and provided to employers, via a mobile app as well as a web app, for example. These employer portal functions may include contribution management 60, savings review 61, budget review 62, employee administration 63, and alerts & alarms 64.

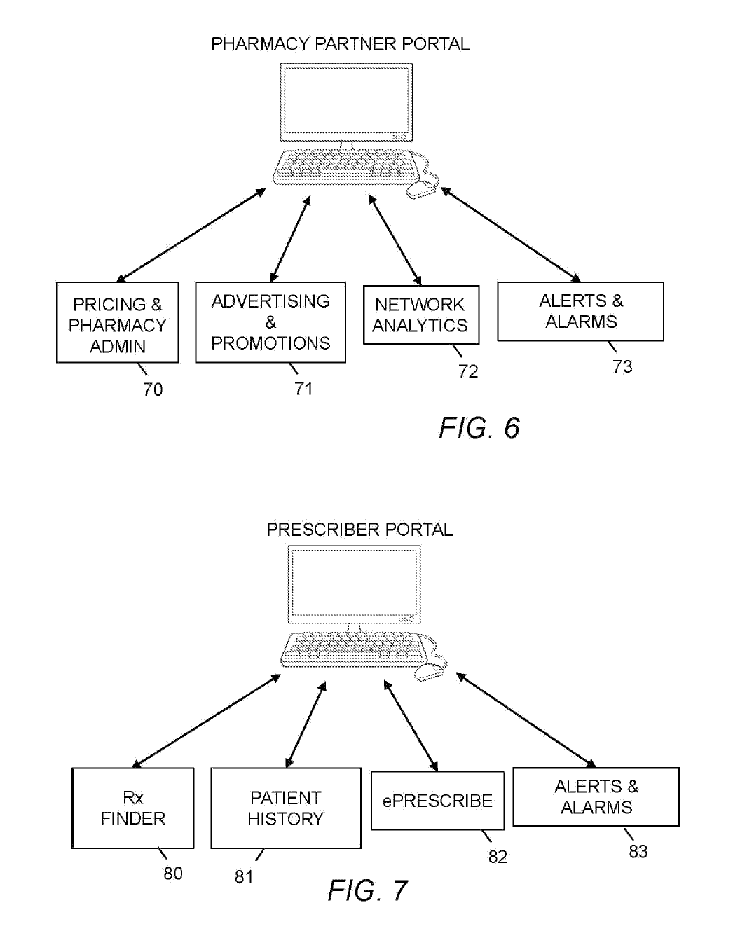

FIG. 6 is a simplified block diagram that illustrates various exemplary functions that are available and provided to pharmacy partners, via a mobile app as well as a web app, for example. These pharmacy portal functions may include pricing & pharmacy administration 70, advertising & promotions 71, network analytics 72, and alerts & alarms 73.

FIG. 7 is a simplified block diagram that illustrates various exemplary functions that are available to and provided to prescribers (e.g., physicians), via a mobile app as well as a web app, for example. These prescriber portal functions may include Rx finder 80, patient history 81, e-prescribe 82, and alerts & alarms 83.

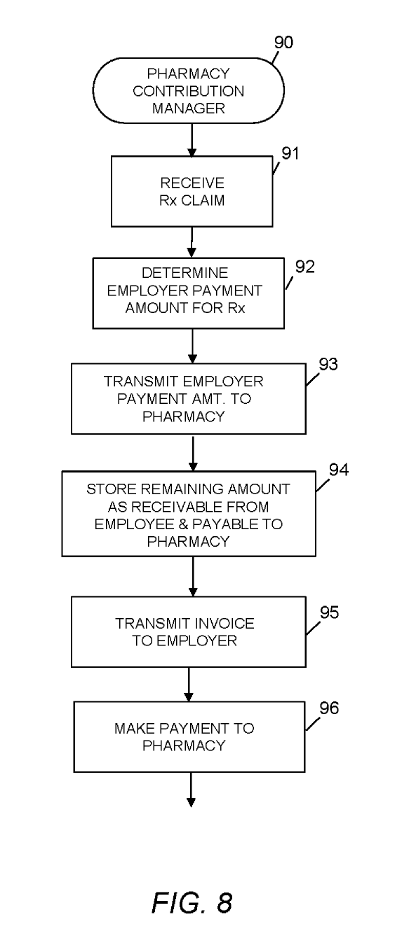

FIG. 8 is a simplified flowchart of an exemplary embodiment of the pharmacy contribution management process 90. The pharmacy receives the Rx claim from an employee, as shown in block 91. Based on the tiered contribution model, the pharmacy determines or is provided the employer's defined contribution either as a fixed percentage or maximum amount, as shown in blocks 92 and 93. For example, if the price of the Rx is $25, and the employer contribution is defined as 60% for drugs that fall into this price range, then the employee is responsible for the remaining 40% of the drug cost. The employee's share of the drug cost is then provided in real-time or stored as a receivable at the pharmacy, as shown in block 94, so that the pharmacy can collect the balance from the employee at the point of sale. Therefore, the employee member is charged and pays an amount that is based on the prescription price and the employer tiered contribution model rather than a fixed copay amount. The employee member has incentive to shop for the lowest cost pharmacy to reduce his/her contribution amount for the prescription. The pharmacies can pass on savings to the customers via pass-through pricing. The invoice is then transmitted to the employer, which pays the pharmacy a fixed amount or percentage for a prescription based on the assigned tier, as shown in blocks 95 and 96.

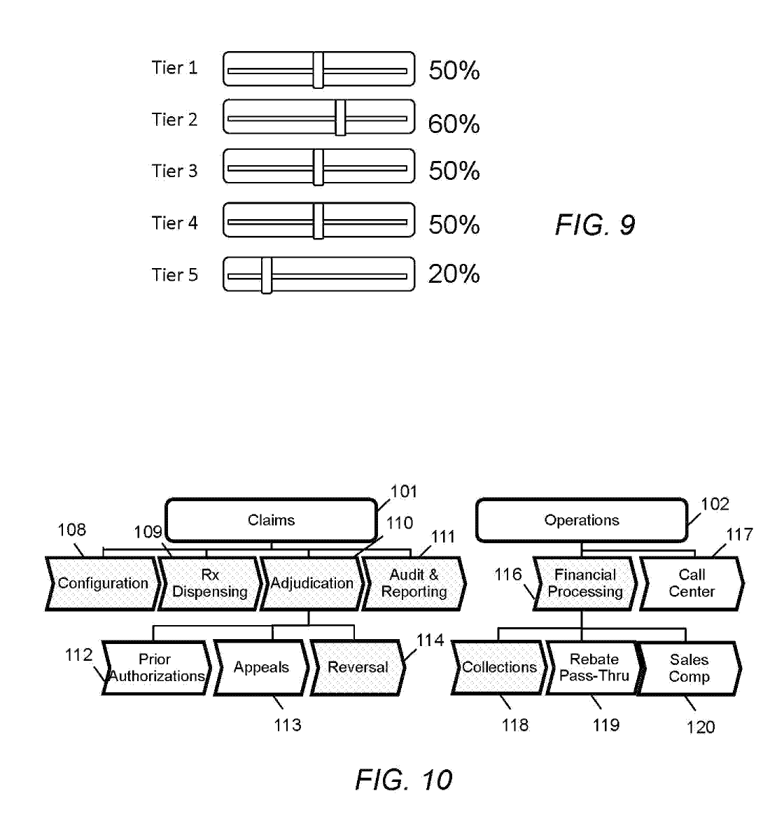

The tired employer contribution model is illustrated in FIG. 9. Historical claims analysis is used to determine the tier structure for a given employer to optimize results. In this example, medication are stratified based on price into five tiers, and the employer contribution may be defined as shown:

| Tier | Price | Employer Contribution |
|---|---|---|
| 1 | $0.01-$20 | 50% |
| 2 | $21-$50 | 60% |
| 3 | $51-$100 | 50% |
| 4 | $101-$300 | 50% |
| 5 | >$301 | 20% |

Thus, the employer set the amount that it will contribute by percentage or maximum amount for all medication in each tier. Each tier defines the drug price range. Historical claims analysis is used to set the tier structure for optimal results. The following is an example contribution model.

| | | | | % of | | | | |
|---|---|---|---|---|---|---|---|---|
| | | | | NDCs | % of | | | Avg. |
| | | | Avg. | in | Rx | E'er | Max E'er | E'ee |
| Tier | Low | High | Cost | Range | Written | Contribution % | Contribution | Expense |
| 1 | $0 | $20 | $4.25 | 27.25% | 38.50% | 50% | $10.00 | $0.00 |
| 2 | $21 | $50 | $38.24 | 32.48% | 29.25% | 60% | $30.00 | $8.24 |
| 3 | $51 | $100 | $86.58 | 21.73% | 18.56% | 50% | $50.00 | $36.58 |
| 4 | $101 | $300 | $207.20 | 12.56% | 10.65% | 50% | $150.00 | $57.20 |
| 5 | $301 | . . . | $2,765.00 | 5.98% | 3.04% | 20% | $1,000.00 | $1,765.00 |

In this example, tier 1 drugs range in cost from $0 to $20 at pharmacies, with the average cost of $4.25. The system suggests the employer's contribution to be 50%, or a maximum of $10 per prescription for tier 1. As a further example, tier 2 drugs range in cost from $21 to $50 at pharmacies, with the average cost of $38.24. The system suggests the employer's contribution to be 60%, or at a maximum of $30 per prescription. Further, tier 3 drugs range in cost from $51 to $100 at pharmacies, with the average cost of $86.58. The system suggests the employer's contribution to be 50%, or at a maximum of $50 per prescription. Tier 4 drugs may range in cost from $101 to $300, with the average cost of $207.20. The system suggests the employer's contribution to be 50%, or at a maximum of $150 per prescription. Finally, tier 5 drugs may range in cost from $301 and up, with the average cost of $2,765.00. The system suggests the employer's contribution to be 20%, and at a maximum of $1,000 per prescription. The employer may select to set its contribution to be in the form of percentage of the prescription cost or a fixed amount. From historical data, the employer is able to determine how many of each type of prescriptions are typically filled at pharmacies by its employees, so with the fixed contribution defined by the employer, it can easily predict and budget for its employee Rx expenses. Using the system and method described herein, employees can and are incentivized to shop for the lowest Rx prices in their area while enabling pharmacies to compete on service and price. The true cost of prescriptions will no longer be hidden but become transparent to all parties. Employees may shop at any pharmacy but by shopping with pharmacy partners, more savings can be realized.

FIG. 10 is a simplified block diagram of an exemplary embodiment of the basic function blocks of the pharmacy contribution management process according to the teachings of the present disclosure. The pharmacy contribution management system and method include claims functions 101 and operations functions 102. Claims functions 101 include configuration 108, Rx dispensing 109, adjudication 110, audit & reporting 111, prior authorizations 112, appeals 113, and reversal 114 modules. Operations functions 102 include financial processing 116, call center 117, collections 118, rebate pass-through 119, and sales compensation 120 modules. Selected functions and modules are described in more detail below.

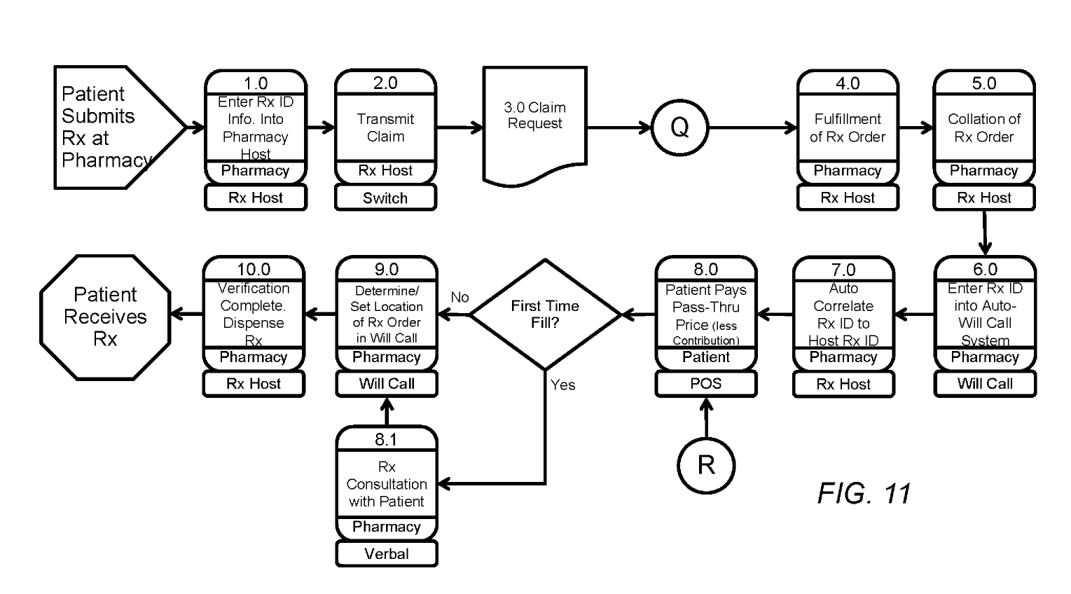

FIG. 11 is a simplified illustration of an exemplary embodiment of the claims processing Rx dispensing process in the pharmacy contribution management process according to the teachings of the present disclosure. The system first receives the Rx ID information, as shown in block 131. The claim request 133 is then transmitted to the pharmacy, as shown in block 132. The Rx may be transmitted via paper copy, eRx, IVR (Interactive Voice Response), or a refill request. The Rx order is then fulfilled, as shown in block 134. The Rx orders are collated, as shown in block 135. The Rx ID is entered into the automatic will call system, as shown in block 136. The Rx ID is also correlated with the Host Rx or pharmacy ID, as shown in block 137. The patient is then requested to pay the pass-through price at the point of sale (POS), which is the price of the drug minus the employer's contribution percentage or amount, as shown in block 138. If this the first time this prescription is filled, as determined in block 139, then the pharmacist is requested to provide Rx consultation with the employee/patient, as shown in block 140. Otherwise, the location of the Rx order is determined or set in the will call system, as shown in block 141. The drug is then dispensed to a verified recipient, as shown in block 142. The patient then receives the prescription, as shown in block 143.

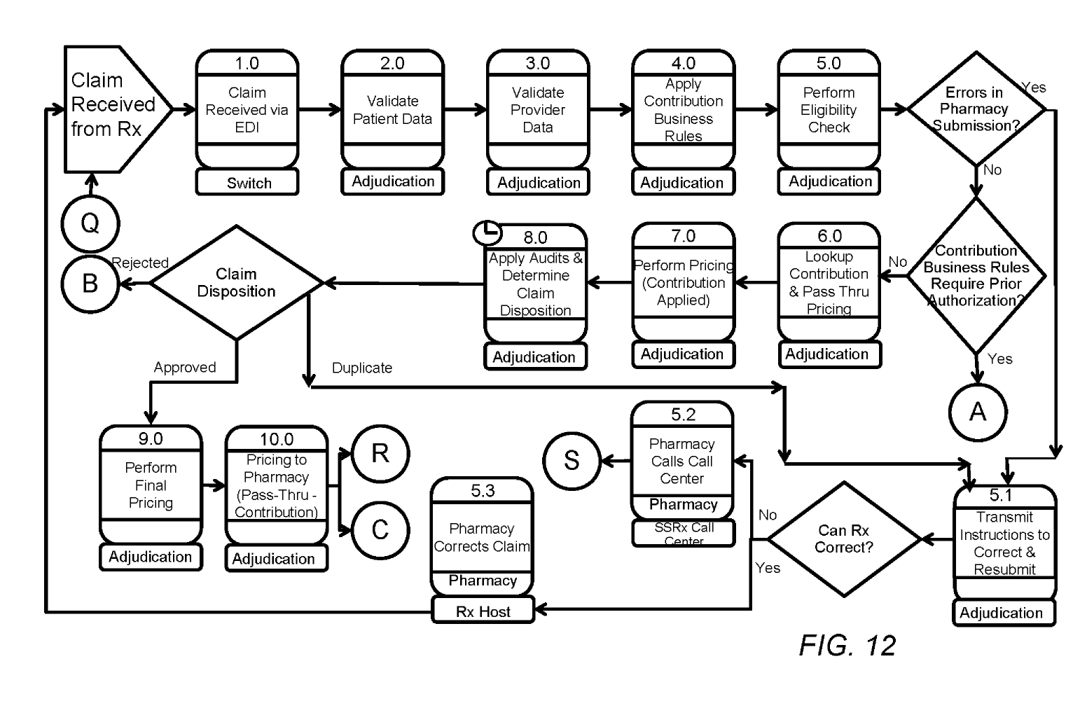

FIG. 12 is a simplified illustration of an exemplary embodiment of the claims adjudication process in the pharmacy contribution management process according to the teachings of the present disclosure.

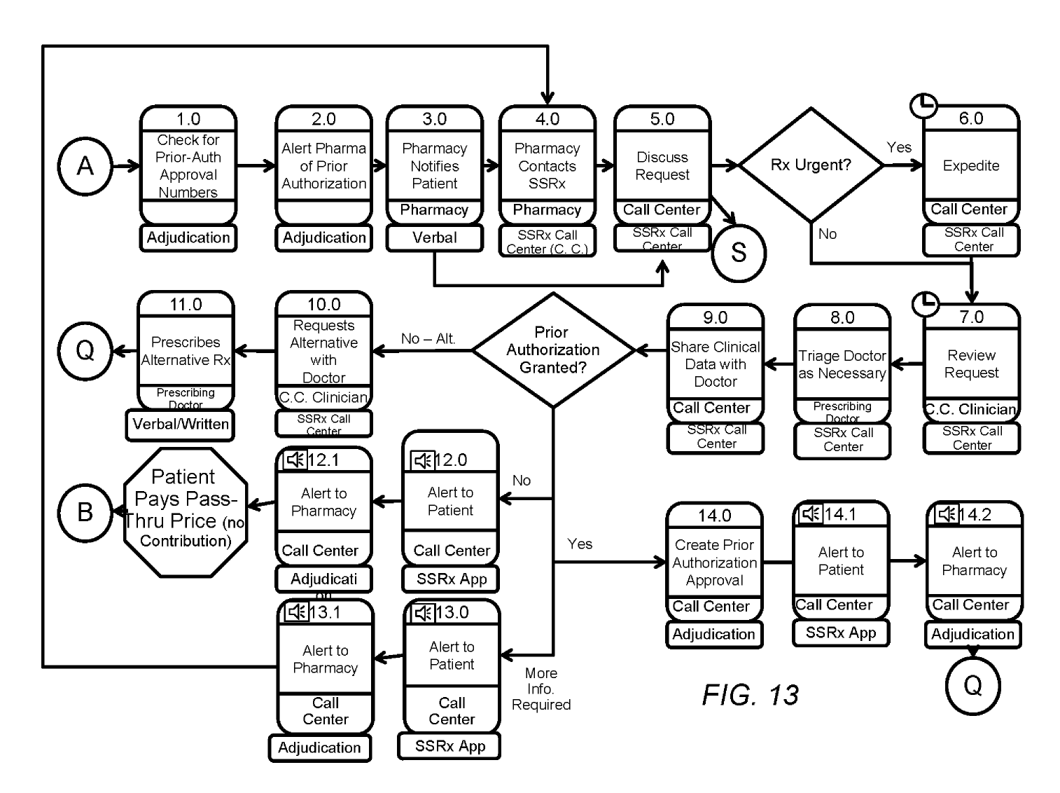

FIG. 13 is a simplified illustration of an exemplary embodiment of prior authorizations in the claim approval process in the pharmacy contribution management process according to the teachings of the present disclosure.

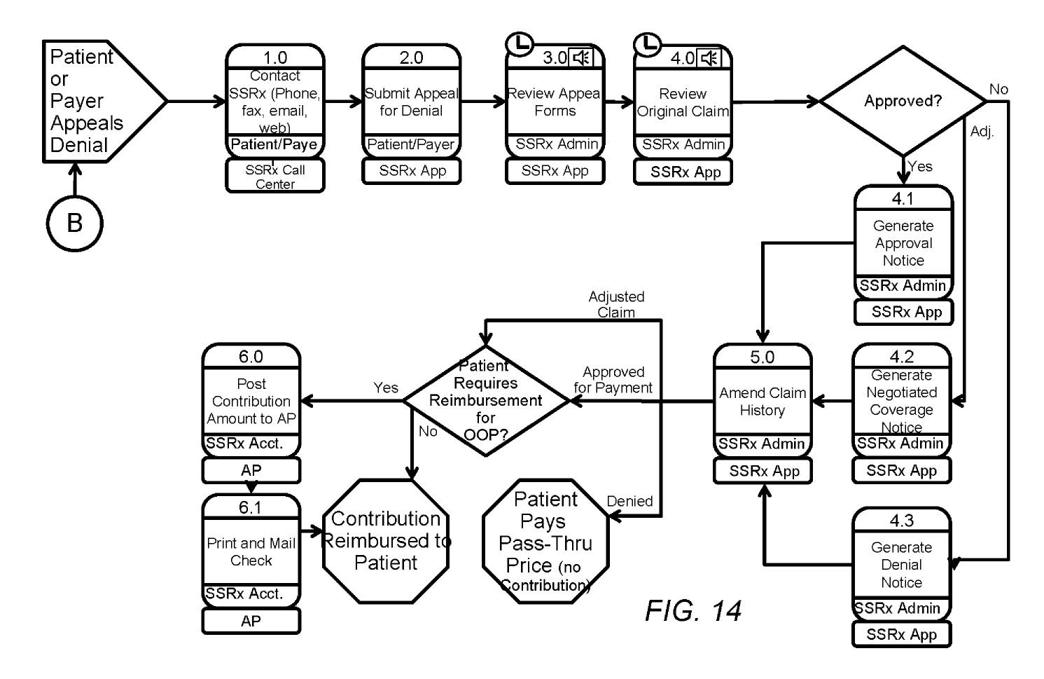

FIG. 14 is a simplified illustration of an exemplary embodiment of the appeals process in claim processing in the pharmacy contribution management process according to the teachings of the present disclosure.

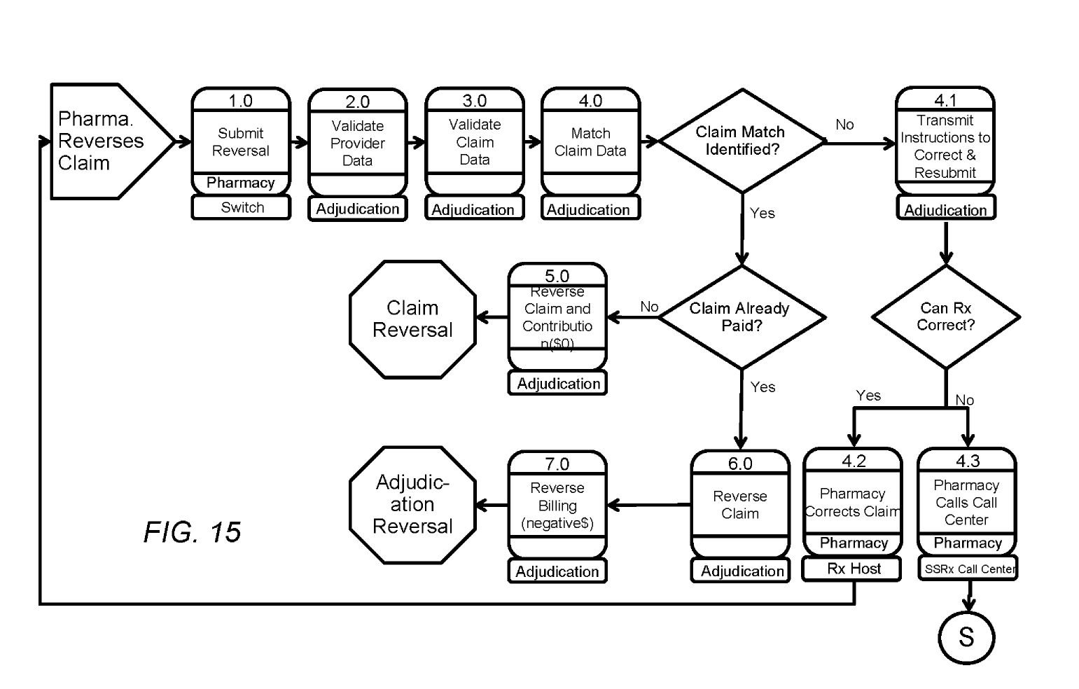

FIG. 15 is a simplified illustration of an exemplary embodiment of the claim reversal process in claim processing in the pharmacy contribution management process according to the teachings of the present disclosure.

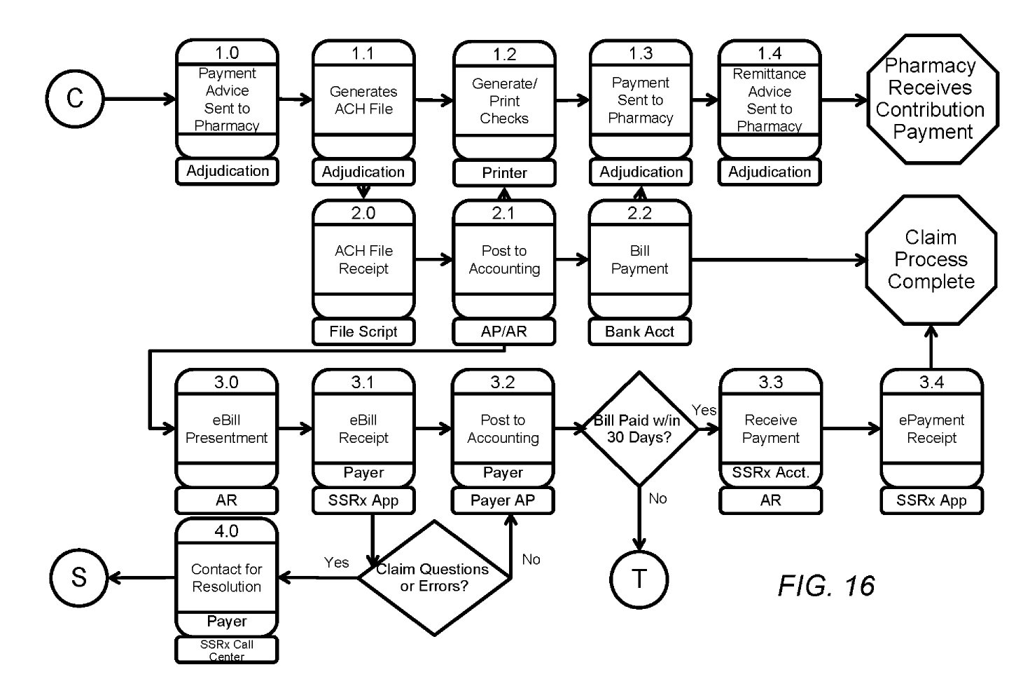

FIG. 16 is a simplified illustration of an exemplary embodiment of the financial processing for Rx payee reimbursement process in the pharmacy contribution management process according to the teachings of the present disclosure.

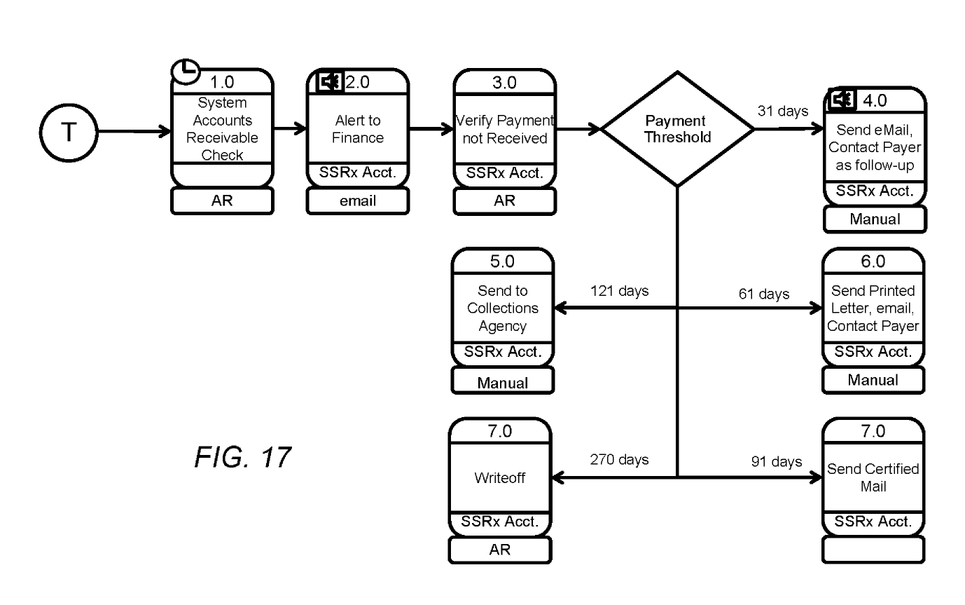

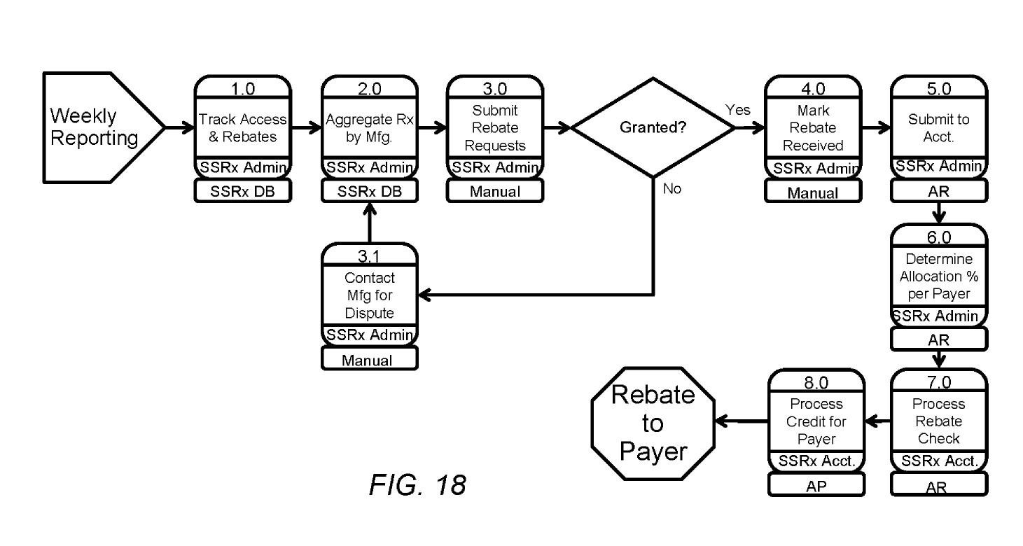

FIG. 17 is a simplified illustration of an exemplary embodiment of the financial processing for payer collections process in the pharmacy contribution management process according to the teachings of the present disclosure.

FIG. 18 is a simplified illustration of an exemplary embodiment of the financial processing for sales and channel compensation process in the pharmacy contribution management process according to the teachings of the present disclosure.

The features of the present invention which are believed to be novel are set forth below with particularity in the appended claims. However, modifications, variations, and changes to the exemplary embodiments described above will be apparent to those skilled in the art, and the novel pharmacy contribution management system and method described herein thus encompasses such modifications, variations, and changes and are not limited to the specific embodiments described herein.

What is claimed is:

1. A pharmacy contribution management method comprising:
analyzing historical claim data;
determining a tiered model for prescription contributions, the tiered model describing a plurality of prescription cost tiers and a recommended prescription contribution for each of the plurality of prescription cost tier;
permitting an organization to define a prescription contribution for each of the plurality of prescription cost tier in response to the tiered model;
enabling a member associated with the organization to shop for lowest price drugs via pass-through pricing offered by a plurality of pharmacies;
receiving a prescription claim from a pharmacy arising from a prescription purchase by the member associated with the organization; and
transmitting the prescription contribution for the organization to the pharmacy, so that the pharmacy may charge the member an amount equal to a price of the prescription minus the organization's prescription contribution according to the defined prescription contribution for the prescription cost tier.

2. The method of claim 1, further comprising receiving an inquiry specifying at least one search criteria for a pharmacy from the member, performing a search function in response to the specified search criteria, and providing a search result to the member.

3. The method of claim 1, further comprising receiving an inquiry specifying at least one search criteria for a prescription pricing from the member, performing a search function in response to the specified search criteria, and providing a search result to the member.

4. The method of claim 1, further comprising receiving an inquiry specifying at least one search criteria for a prescription from the member, performing a search function in response to the specified search criteria, and providing a search result to the member.

5. A pharmacy contribution management system having specialized computing logic configured to:
analyze historical claim data;
determine a tiered model for prescription contributions, the tiered model describing a plurality of prescription cost tiers and a recommended prescription contribution for each of the plurality of prescription cost tier;
permit an organization to determine a prescription contribution for each of the plurality of prescription cost tier;
enable a member associated with the organization to shop for lowest price drugs via pass-through pricing from the pharmacies;
receive a prescription claim from a pharmacy arising from a prescription purchase by the member associated with the organization; and
transmit the prescription contribution for the organization to the pharmacy, so that the pharmacy may charge the member an amount equal to a price of the prescription minus the organization's prescription contribution according to the defined prescription contribution for the prescription cost tier.

6. A pharmacy contribution management system comprising:
a financial history database;
a claims history database;
a drug market pricing database;
an analytics engine;
user application and interface logic adapted to:
analyze historical claim data in the claims history database;
determine a tiered model for prescription contributions, the tiered model describing a plurality of prescription cost tiers and a recommended prescription contribution for each of the plurality of prescription cost tier;
permit an organization to define a prescription contribution amount for each of the plurality of prescription cost tier;
receive a prescription claim from a pharmacy arising from a prescription purchase by the member associated with the organization; and
transmit the prescription contribution for the organization to the pharmacy, so that the pharmacy may charge the member an amount equal to a price of the prescription minus the organization's prescription contribution according to the defined prescription contribution amount for the prescription cost tier.

7. A pharmacy contribution management method comprising:
receiving and storing a company's definition of a tiered model for prescription contributions having a plurality of tiers, each tier describing a prescription cost range and a prescription contribution amount;
receiving a prescription claim from a member associated with the company submitted to a pharmacy;
determining a prescription cost of the prescription specified in the prescription claim submitted by the member;
determining the company's contribution amount for the prescription in response to the prescription cost and the defined company's prescription contribution amount; and
transmitting the company's prescription contribution to the pharmacy, so that the pharmacy may charge the member an amount equal to the prescription cost minus the company's prescription contribution amount according to the defined tiered model for prescription contribution.

8. The method of claim 7, further comprising enabling the member associated with the company to shop for lowest price drugs via pass-through pricing offered by a plurality of pharmacies.
